(19) United States
(12) Patent Application Publication
(10) Pub. No.: US 2021/0123800 A1
(43) Pub. Date: Apr. 29, 2021

(54) SYSTEM FOR MEASURING COMPONENTS OF SOLAR RADIATION

(71) Applicant: CENTRE NATIONAL DE LA RECHERCHE SCIENTIFIQUE, PARIS (FR)

(72) Inventors: Stéphane GRIEU, RIVESALTES (FR); Remi CHAUVIN, SAINT MARTIN D'URIAGE (FR); Stéphane THIL, POLLESTRES (FR); Julien NOU, BROUILLA (FR)

(21) Appl. No.: 16/647,129

(22) PCT Filed: Sep. 14, 2018
(86) PCT No.: PCT/EP2018/074973

§ 371 Date: Mar. 13, 2020

(30) Foreign Application Priority Data
Sep. 14, 2017 (FR) 17 58549

(51) Int. Cl. G01J 1/42; H04N 5/232; H04N 5/225; G06F 17/11

(52) U.S. Cl. CPC G01J 1/42; H04N 5/23229; G01J 2001/4266; G06F 17/11; H04N 5/2252

(57) ABSTRACT

Disclosed is a system for measuring solar radiation, with a camera having a hemispherical objective and light sensor, and a processor to: perform a geometric calibration of the camera establishing correspondence between coordinate systems of the image pixels and the camera; calculate the solid angle occupied by each pixel; perform a second calibration by comparing the theoretical position of the sun and its position in the image, establishing correspondence between the camera coordinate system and the cardinal points; calculate the angles between: each pixel and the zenith; each pixel and the azimuth; the sun and the zenith; and the sun and the azimuth; then each pixel and the sun. The next steps are: obtain a high-dynamic-range image of the sky; calculate the global horizontal irradiance, the direct normal irradiance, and the diffuse horizontal irradiance; and convert, into global horizontal luminance, direct normal irradiance and diffuse horizontal irradiance, respectively.

### BACKGROUND OF THE INVENTION

### Field of the Invention

The present invention relates to the field of solar radiation and properties of the atmosphere.

The invention relates more particularly to a system for measuring solar radiation.

### Description of the Related Art

For some applications, it is necessary to know the different components of solar radiation. In particular, we want to know the following components:
The direct component of solar radiation.

When the solar radiation which does not interact with the Earth's atmosphere during its passage and is measured under normal incidence, we speak of normal direct illumination or DNI (Direct Normal Irradiance). The DNI is expressed in Wm⁻².

A pyrheliometer is generally used to measure the DNI; this is in the form of a tube the dimensions of which define the opening angle, and at the bottom of which is placed a thermopile. The pyrheliometer must be aligned with the axis of the sun; this is why a solar tracker is necessary if one wishes to automate the acquisition of the DNI. The cost of a pyrheliometer is around 2.5 k€, while that of a solar tracker is close to 10 k€. In addition and to function optimally, this instrument must be maintained daily. Faced with these constraints of cost and maintenance, less expensive and more robust instruments have been developed. Among them, the instrument most used is the rotating band pyranometer (see below). However, the pyranometer has the disadvantage of requiring an accurate spectral calibration of the photodiode. This calibration is complex and produces a higher uncertainty on the DNI than for a pyrheliometer.
The diffuse component of solar radiation.

When the solar radiation that interacted with the Earth's atmosphere during its passage is measured on a horizontal surface, we speak of Horizontal Diffuse Irradiance (HID). The DHI is expressed in Wm⁻².

Most often and in order to measure DHI, a pyranometer and a solar tracker equipped with an element that masks the Sun are used together (thus allowing the suppression of the direct component of solar radiation). For example, a rotating band periodically obscures the photodiode in order to measure the DHI.
Global solar radiation is defined as the sum of direct and indirect radiation received on the ground. If this radiation is measured horizontally, we speak of Global Horizontal Irradiance (GHI).

The GHI is expressed in Wm⁻².

A pyranometer is generally used to measure GHI, and includes a horizontally-mounted photodiode.

The DNI can be determined from measurements of GHI and DHI and knowledge of the position of the Sun.

In fact, GHI, DNI and DHI are linked by the following relationship:

GHI=cos(SZA)·DNI+DHI

where SZA is the angle between the Sun and the zenith.
In some cases, we also want to know the duration of sunshine.

The duration of sunshine of a geographic area refers to how long this geographical area is illuminated by the sun.

The World Meteorological Organization (WMO) defines the duration of sunshine as the time during which the direct solar radiation exceeds the threshold of 120 Wm⁻².

In some cases, we also want to know the atmospheric disorder.

The atmospheric disorder relates to the attenuations of solar radiation during its passage through the Earth's atmosphere. This attenuation is mainly due to the phenomena of diffusion by aerosols and subsequent absorption by the various atmospheric components (ozone, water vapor, oxygen . . . ).

The atmospheric disorder gives a reliable indication of the quality of the solar resource or the atmosphere for a given site.

For example, an estimate of the atmospheric disorder (TA) is performed using the relationship:

$$TA = 11.1 \frac{ln ( b \frac{{I}_{0}}{{I}_{cc}} )}{m} + 1 with b = 0.664 + 0.163 \cdot exp ( \frac{- h}{8000} )$$

where h is the altitude of the site in question, l₀ is the extraterrestrial solar illumination (Wm⁻²), I_{CC} is the DNI with a clear sky (Wm⁻²), and m is the relative optical air mass.

In certain cases, we also want to know the solar profile, i.e. the distribution of the luminance L in the circumsolar zone, i.e. the zone comprised between the exterior of the solar disk (about 0.26°) and the conventional half-angle of the DNI measuring instruments. In practice, the circumsolar zone is therefore defined by the condition 0.26°<SPA<β, where SPA is the angle between the pixel and the Sun, and β is between 1° and 5°.

The energy luminance, noted and expressed in Wm⁻²·sr⁻¹, is the flux radiated per unit of solid angle and surface. The luminance energy L is tied to the illuminance I by the relationship:

I=_{φ=0}^{2π}∫_{θ=0}^{π/2}L(θ,φ)cos θ·dΩ

where dΩ is the elementary solid angle, θ and φ defining the direction of propagation of the light.

For isotropic radiation, we have I=π·L.

The most accurate instrument for this measurement is the SAM (Sun Aureole Measurement) instrument. This instrument presents the disadvantage of a very high cost (about 80 k€).

Each of the above-mentioned instruments has a minimum cost of several thousand euros and requires regular maintenance, both for the solar tracker and for the sensors themselves. Measuring the different components of solar radiation is therefore an expensive and restrictive process.

### SUMMARY OF THE INVENTION

The present invention aims to remedy these drawbacks.

The invention proposes a system making it possible to measure the components of solar radiation more easily and at lower cost.

This goal is achieved thanks to the fact that the system includes a camera equipped with a hemispherical objective and a sensor capable of capturing light to generate an image, and a processor capable of:
Performing a geometric calibration of the camera in order to obtain correspondence between the coordinate system of the image pixels and the coordinate system of the camera.
Calculating the solid angle subtended by each pixel of the image, which will make it possible to weight the value of the luminance in the subsequent calculations.
Performing a camera calibration giving the position of the Sun in the sky to obtain correspondence between the camera's coordinate system and the cardinal points.
Calculating the angle between each pixel and the zenith (PZA), the angle between each pixel and the azimuth (PAA), the angle between the Sun and the zenith (SZA), and the angle between the Sun and the azimuth (SAA), then the angle between each pixel and the Sun (SPA), using the relation:

cos(SPA)=cos(SZA)·cos(PZA)+sin(SZA)·sin(PZA)·cos(|SAA−PAA|)
Obtaining a High Dynamic Range (HDR) image of the sky.
Calculating the overall horizontal illuminance index (θ_{GHI}), the direct normal illuminance index (σ_{DNI}), and the horizontal diffuse illuminance index (σ_{DHI}), defined as the sum of the luminances measured by the pixels of the image belonging to a first region of interest (Λ₁), to a second region of interest (Λ₂), and to a third region of interest (Λ₃), respectively, by using the formulas below, where Ωp, Lp and PZA are the solid angle subtended by a pixel p, the luminance measured by this pixel and the angle between this pixel and the zenith, respectively:

$${σ}_{GHI} = \frac{{\sum }_{p ∈ {Λ}_{1}} {L}_{p} {Ω}_{p} cos ( PZA )}{{\sum }_{p ∈ {Λ}_{1}} {Ω}_{p}}$$

$${σ}_{DNI} = \frac{{\sum }_{p ∈ {Λ}_{2}} {L}_{p} {Ω}_{p}}{{\sum }_{p ∈ {Λ}_{2}} {Ω}_{p}}$$

$${σ}_{DHI} = \frac{{\sum }_{p ∈ {Λ}_{3}} {L}_{p} {Ω}_{p}}{{\sum }_{p ∈ {Λ}_{3}} {Ω}_{p}}$$

Converting the Global Horizontal Irradiance (σ_{GHI}) index, the Direct Normal Irradiance (σ_{DNI}) index, and the Diffuse Horizontal Irradiance (σ_{DHI}) index, into Global Horizontal Irradiance (GHI), Direct Normal Irradiance (DNI) and Diffuse Horizontal Irradiance (DHI), respectively.

Thanks to these provisions, an estimate of the various components of solar radiation (DNI, GHI, DHI) is obtained with a single camera, which advantageously replaces several measuring instruments. The system according to the invention is therefore less expensive in terms of purchase and maintenance as well as being less complex.

In addition, the system according to the invention does not use a mask which obscures the Sun. There is therefore elimination of the operating and maintenance costs of a mask and of the costs associated with a mechanical system ensuring the tracking of the path of the Sun. In addition, given that the Sun remains visible during the measurements, the algorithms for estimating the different components are more efficient.

Advantageously, the High Dynamic Range (HDR) image is obtained by the acquisition of several low dynamic images taken with different exposure times and then the combination of these images into an HDR image, while retaining the linearity of the camera sensor.

Advantageously, the first region of interest (Λ₁) is the set of pixels of the image verifying PZA<90°, the second region of interest (Λ₂) is the set of pixels of the image verifying SPA<β, where β is the angle defined as the limit between the circumsolar zone and the rest of the sky, and the third region of interest (Λ₃) is the set of pixels of the image verifying {SPA<β}∩{PZA<90°}.

Thus, reliable values are obtained for the various components of solar radiation.

Advantageously, the measurement system includes a waterproof and dustproof protective box in which the camera is housed, and which includes a transparent window located in front of the camera objective.

Thus, the camera is protected from bad weather (rain and wind) and foreign bodies.

Advantageously, the protective box is equipped with a temperature regulator capable of regulating the temperature inside the box.

Thus, the system is able to operate in a hostile environment, for example on the site of implantation of a solar power station, where the temperatures are sometimes very high.

Advantageously, the system comprises at least one filter which is capable of attenuating or modulating the light entering through the objective into the camera.

The invention also relates to a method for measuring solar radiation.

According to the invention, this method of measuring solar radiation uses a camera provided with a hemispherical objective and comprising a sensor capable of capturing light to generate an image, and a processor, while this method comprises the steps:

(a) The camera is geometrically calibrated in order to obtain correspondence between the pixel coordinate system of the image supplied by the camera and the coordinate system of the camera.
(b) The solid angle subtended by each pixel of the image is calculated in order to weight the value of the luminance in the subsequent calculations.
(c) The camera is calibrated a second time by comparing the theoretical position of the Sun with its position on the image obtained. In this way, the correspondence between the coordinate system of the camera and the cardinal points is obtained.
(d) We calculate the angle between each pixel and the zenith (PZA), the angle between each pixel and the azimuth (PAA), the angle between the Sun and the zenith (SZA), and the angle between the Sun and the azimuth (SAA), then the angle between each pixel and the Sun (SPA), thanks to the relationship:

cos(SPA)=cos(SZA)·cos(PZA)+sin(SZA)·sin(PZA)·cos(|SAA−PAA|)

(e) A High Dynamic Range (HDR) image of the sky is obtained.
(f) We calculate the Global Horizontal Irradiance (σ_{GHI}) index, the Direct Normal Irradiance (σ_{DNI}) index, and the Diffuse Horizontal Irradiance (σ_{DHI}) index, where Op, Lp and PZA are the solid angle subtended by a pixel p, the luminance measured by this pixel and the angle between this pixel and the zenith, respectively:

$${σ}_{GHI} = \frac{{\sum }_{p ∈ {Λ}_{1}} {L}_{p} {Ω}_{p} cos ( PZA )}{{\sum }_{p ∈ {Λ}_{1}} {Ω}_{p}}$$

$${σ}_{DNI} = \frac{{\sum }_{p ∈ {Λ}_{2}} {L}_{p} {Ω}_{p}}{{\sum }_{p ∈ {Λ}_{2}} {Ω}_{p}}$$

$${σ}_{DHI} = \frac{{\sum }_{p ∈ {Λ}_{3}} {L}_{p} {Ω}_{p}}{{\sum }_{p ∈ {Λ}_{3}} {Ω}_{p}}$$

(g) A conversion is carried out between the Global Horizontal Irradiance (σ_{GHI}) index, the Direct Normal Irradiance (σ_{DNI}) index, and the Diffuse Horizontal Irradiance (σ_{DHI}) index, and the Global Horizontal Irradiance (GHI), Direct Normal Irradiance (DNI) and Diffuse Horizontal Irradiance (DHI), respectively.

Advantageously, the method according to the invention further comprises the following step:

(h) The solar profile is calculated by measuring the Direct Normal Irradiance (DNI) along a line of pixels passing through the center of the Sun on the image, then this measurement is repeated for a plurality of angles, in order to obtain the radial distribution of the luminance around the Sun.

Thus, the use of expensive additional equipment is avoided, and a measurement of the solar profile is obtained that is more precise, since this measurement takes into account the anisotropy of the luminance around the Sun.

### BRIEF DESCRIPTION OF THE DRAWINGS

The invention will be better understood and its advantages will become more apparent upon reading the detailed description which follows, of an embodiment shown by way of non-limiting example. The description refers to the accompanying drawings in which:

FIG. 1 is a schematic view of a measurement system according to the invention;

FIG. 2 is a diagram illustrating the correspondence between a camera sensor of the pixel of the system according to the invention and a solid angle;

FIG. 3 is a diagram showing the different angles used to define the position of the Sun and of a pixel of the camera of the system according to the invention with respect to a reference.

### DESCRIPTION OF THE PREFERRED EMBODIMENTS

The system according to the invention comprises a camera 10, equipped with a hemispherical objective 20 (also called a “fisheye” objective), i.e. a lens with a large angle of field, with a field of vision greater than 180°. The camera 10 includes a sensor 12 capable of capturing light to generate an image, for example a CMOS (Complementary Metal Oxide Semiconductor) sensor or a CCD (Charge Coupled Device) sensor. The sensor 12 comprises on its surface a certain number of pixels (125) on which the light terminates to form an image.

Advantageously, the camera 10 is located on a horizontal platform, and is located in a place where there is no shading (for example, high up and far from buildings and vegetation). Thus, one can obtain an image of all, or almost all of the sky, without obstacles hiding parts of the sky.

The camera 10 is oriented along a Z axis which points from the ground towards the zenith.

Advantageously, the measurement system comprises a protective case 40 that is waterproof and dustproof, and in which the camera 10 is housed.

The box 40 has a transparent window 42, for example a transparent dome as shown in FIG. 1, which is located in front of the objective 20 of the camera 10 and which protects this objective 20. Thus, the transparent window 42 is located between the objective 20 and the sun.

Thus, the camera 10 is protected from water and from dust, while letting sunlight reach the objective 20.

Advantageously, the protective box 40 is equipped with a temperature regulator 50 capable of regulating the temperature inside the box 40.

Thus, condensation inside the box 40 is reduced or prevented. Consequently, the images taken by the camera 10 are not polluted by humidity.

Advantageously, the system comprises one or more filters 60, which are capable of attenuating or modulating the light entering the camera 10.

The filter(s) 60 are positioned between the Sun and the camera 10. Thus, the filter(s) 60 are located either between the camera 10 and the objective 20, or in the objective 20, or in front of the objective 20, or a combination of these positions.

For example, the internal face of the transparent window 42 is covered with a filter 60, as shown in FIG. 1 in the case where the window 42 is a dome.

Advantageously, the transparent window 42 is tinted in order to attenuate the stray reflections (which could, mistakenly, be taken for clouds by the algorithms developed).

Alternatively, the transparent window 42 is not tinted. In this case, the processor 30 (see below) includes an algorithm that suppresses these parasitic reflections.

The system according to the invention comprises a processor 30 connected to the camera 10.

This processor 30 is able to perform the following operations:
Perform a first calibration of the camera 10 to obtain the correspondence between the coordinate system of the pixel 125 of the image produced by the sensor 12 and the coordinate system of the camera 10. This calibration geometry is performed, in a known manner, for example, with the assistance of a checkerboard and an algorithm.
Calculate, in a known manner, the solid angle Ωp subtended by each pixel (125, p) of the sensor 12 of the camera 10 recording the images, in order to weight the value of the luminance L in the subsequent calculations.

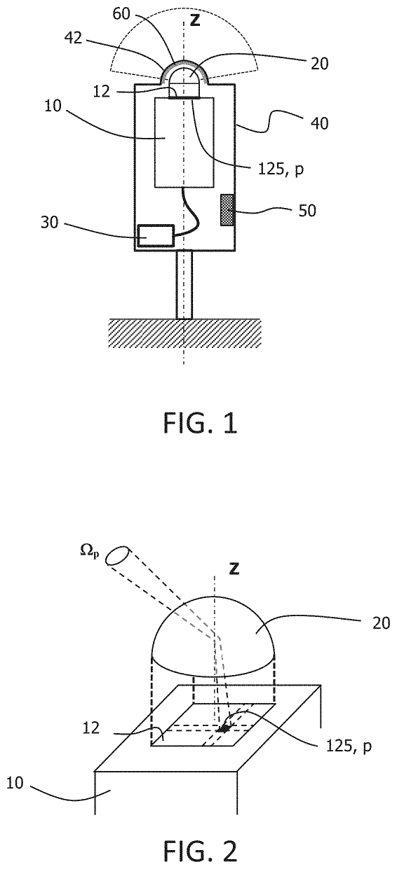

FIG. 2 illustrates a solid angle Ωp and shows the correspondence between this solid angle Ωp and a pixel (125, p) of the sensor 12.
Perform a second calibration of the camera 10 by comparing the theoretical position of the Sun with its position obtained on the image. In this way, the correspondence between the coordinate system of the camera 10 and the cardinal points (mark X, Y, Z) is obtained. The theoretical position of the Sun is obtained in a known manner, for example, with the aid of an algorithm such as SPA (Solar Position Algorithm) or SG (Solar Geometry).
Calculate the angle between each pixel (125, p) and the zenith (PZA), the angle between each pixel and the azimuth (PAA), the angle between the Sun and the zenith (SZA), and the angle between the Sun and the azimuth (SAA), then the angle between each pixel (125, p) and the Sun (SPA), by the relationship:

cos(SPA)=cos(SZA)·cos(PZA)+sin(SZA)·sin(PZA)·cos(|SAA−PAA|)

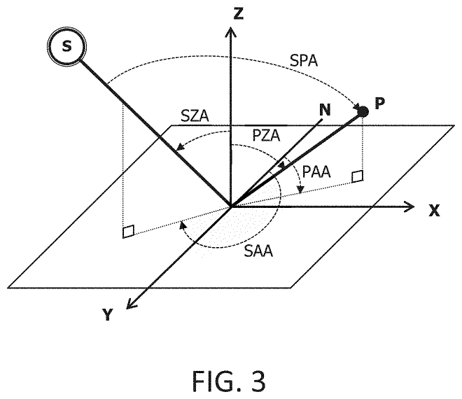

FIG. 3 shows the relationship between these different angles, the Sun S, and the zenith Z, as well as the north reference direction (N, cardinal points).

A High Dynamic Range (HDR) image is defined as an image on which is faithfully restored (i.e. without underexposure or overexposure) all the luminance of the sky, from the luminance Lₘᵢₙ of the darkest zone at the luminance Lₘₐₓ of the brightest area (Sun). Taking account of all of the luminance by a camera means that the camera sensor has a dynamic range DR_{cam} at least equal to the dynamic range of the sky DR_{sky} with:

$${DR}_{cam} = 20 {log}_{10} ( \frac{{L}_{2}}{{L}_{1}} ) and {DR}_{sky} = 20 {log}_{10} ( \frac{{L}_{max}}{{L}_{mi n}} )$$

where L₁ is the luminance minimum measurable by the sensor of the camera and L₂ is the maximum luminance measurable by the camera sensor.

If this condition is not verified, i.e. if the sensor 12 of the camera 10 is capable of taking only Low Dynamic Range (LDR) images, the High Dynamic Range image is obtained by the acquisition of several LDR images and then the combination of these images into one HDR image, while preserving the linearity of the sensor, in a known manner. An example of a method for obtaining an HDR image is described below.

Either several HDR images taken with different exposure times, wherein the total acquisition time of the LDR image sequence must be short enough to guarantee that the movement of the clouds between each LDR image is negligible, in other words that the luminance of the scene is constant during the acquisition. In addition, it is important to properly configure the desired number of LDR images as well as the minimum exposure times tₘᵢₙ and maximum exposure tₘₐₓ so that the dynamic range that can theoretically be scanned by the HDR image verifies the relationship:

$${DR}_{H} = {DR}_{L} + 20 {log}_{10} ( \frac{{t}_{max}}{{t}_{min}} ) > {DR}_{sky}$$

where DR_{H} is the dynamic range of the HDR image and DR_{L} is the dynamic range of the LDR image. The estimated value of each pixel of the generated HDR image is obtained from a weighted average of the pixel value of each LDR image (considering only the pixels within the linearity range of the sensor).

Alternatively, the HDR image is obtained using a sensor 12 with a dynamic range greater than the dynamic range of the DR_{sky}.

According to the invention, one then calculates the Global Horizontal Irradiance (σ_{GHI}) index, the value of the Direct Normal Irradiance (σ_{DNI}) index, and the Diffuse Horizontal Irradiance (σ_{DHI}) index, defined as the sum of the luminances measured by the pixels (125) of the image belonging to a first region of interest (Λ₁), to a second region of interest (Λ₂), and to a third region of interest (Λ₃), respectively, these sums being weighted by the solid angle of the region considered.

Thus, these lighting indices are obtained as follows:

$${σ}_{GHI} = \frac{{\sum }_{p ∈ {Λ}_{1}} {L}_{p} {Ω}_{p} cos ( PZA )}{{\sum }_{p ∈ {Λ}_{1}} {Ω}_{p}}$$

$${σ}_{DNI} = \frac{{\sum }_{p ∈ {Λ}_{2}} {L}_{p} {Ω}_{p}}{{\sum }_{p ∈ {Λ}_{2}} {Ω}_{p}}$$

$${σ}_{DHI} = \frac{{\sum }_{p ∈ {Λ}_{3}} {L}_{p} {Ω}_{p}}{{\sum }_{p ∈ {Λ}_{3}} {Ω}_{p}}$$

where Ωp is the solid angle subtended by a pixel p (see FIG. 2), Lp is the luminance measured by this pixel and PZA is the angle between this pixel and the zenith (see FIG. 3).

Advantageously, the first region of interest (Λ₁) is the set of pixels (125) of the image verifying PZA<90°, the second region of interest (Λ₂) is the set of pixels (125) image verifying SPA<β, where β is the angle defined as the boundary between the circumsolar zone (as defined previously above) and the rest of the sky, and the third region of interest (Λ₃) is the set of pixels (125) of the image verifying {SPA<β}∩{PZA<90° }.

This gives a more precise evaluation of the lighting indices.

Then Global Horizontal Irradiance (σ_{GHI}) index, the Direct Normal Irradiance (σ_{DNI}) index, and the Diffuse Horizontal Irradiance (σ_{DHI}) index, are converted to Global Horizontal Irradiance (GHI), Direct Normal Irradiance (DNI) and Diffuse Horizontal Irradiance (DHI), respectively, by the conversion functions

These conversion functions consist of correlations between the irradiation indices (σ_{GHI}, σ_{DNI} and σ_{DHI}) and the various components of the solar irradiance (GHI, DNI and DHI).

A simple or even multiple linear regression when several lighting indices and, possibly, their histories are taken into account, should make it possible to approximate each conversion function.

Alternatively, it is possible to approximate these functions through the use of artificial intelligence tools, for example a network of artificial neurones or a neuro-fuzzy system (such a system combines the structure of a connectionist neural network and writing fuzzy rules; fuzzy logic is an extension of Boolean logic). A digital learning phase allows, from a base of examples (learning is supervised here), one to determine the topology of the considered tool (structure) and to identify the parameters.

The invention also relates to a process for measuring solar radiation using a camera 10 provided with a hemispherical objective 20 and comprising a sensor adapted to capture light to generate an image, and a processor 30, which comprises the following steps, already described above:

(a) Geometric calibration to obtain the correspondence between the coordinate system of the pixels of the image provided by the camera and the coordinates system of the camera.
(b) Calculation of the solid angle subtended by each pixel of the image, in order to weight the value of the luminance in the subsequent calculations.
(c) Second calibration based on the comparison between the theoretical position of the sun and its position obtained on the image, in order to obtain the correspondence between the coordinate system of the camera and the cardinal points.
(d) Calculation of the angle between each pixel (125, p) and the zenith (PZA), of the angle between each pixel and the azimuth (PAA), of the angle between the Sun and the zenith (SZA), and the angle between the sun and the azimuth (SAA), and the angle between each pixel (125, p) and the sun (SPA), by the relationship:

cos(SPA)=cos(SZA)·cos(PZA)+sin(SZA)·sin(PZA)·cos(|SAA−PAA|)

(e) Obtaining an HDR image of the sky.
(f) Calculation of a Global Horizontal Irradiance (σ_{GHI}) index, of a Direct Normal Irradiance (σ_{DNI}) index, and of the Diffuse Horizontal Irradiance (σ_{DHI}) index, where Ωₚ, Lₚ and PZA are the solid angle subtended by a pixel p, the luminance measured by this pixel, and the angle between this pixel and the zenith, respectively:

$${σ}_{GHI} = \frac{{\sum }_{p ∈ {Λ}_{1}} {L}_{p} {Ω}_{p} cos ( PZA )}{{\sum }_{p ∈ {Λ}_{1}} {Ω}_{p}}$$

$${σ}_{DNI} = \frac{{\sum }_{p ∈ {Λ}_{2}} {L}_{p} {Ω}_{p}}{{\sum }_{p ∈ {Λ}_{2}} {Ω}_{p}}$$

$${σ}_{DHI} = \frac{{\sum }_{p ∈ {Λ}_{3}} {L}_{p} {Ω}_{p}}{{\sum }_{p ∈ {Λ}_{3}} {Ω}_{p}}$$

(g) Conversion between σ_{GHI}, σ_{DNI} and σ_{DHI} and GHI, DNI and DHI.

Advantageously, the method according to the invention further comprises the following step:

(i) Calculation of the sunshine duration from the direct sunlight.

The method according to the invention then comprises providing a time counter that measures the time when the duration of sunlight is greater than the threshold previously described above, and which stops when the duration of sunlight becomes less than this threshold. We then know the duration of sunshine over a chosen period, for example, a day, a month, or a year.

Advantageously, the method according to the invention further comprises the following step:

(j) Calculation of the pheric disorder from the determination of the “clear sky” moments and the DNI.

The atmospheric disorder relates to the attenuations of the solar radiation during its passage through of the Earth's atmosphere. This attenuation is mainly due to the phenomena of diffusion by aerosols and absorption by the various atmospheric components (ozone, water vapor, oxygen . . . ).

The atmospheric disorder gives a good indication of the quality of the solar resource or the atmosphere for a given site.

From the images acquired by the camera 10, the system according to the invention is capable of determining the evolution of the atmospheric disorder on the site studied.

For this, the system detects, with the aid of an algorithm, the moments when the sun is not obscured by a cloud. This is called the “clear sky” position.

An algorithm for detecting “clear sky” instants therefore proceeds to acquire an image or several successive images taken with different exposure times, in a relatively short period of time (for example, a few milliseconds). The system then analyzes the distribution of the luminance in the circumsolar zone and, if necessary, detects a contour of the Sun, in a known manner.

From these parameters so obtained, the system uses this algorithm to determine whether the instant corresponds or not to a so-called “clear sky” situation.

As an option, time filtering, based on several successive images, can be used to ensure that this situation is correctly detected.

Each time a “clear sky” instant is determined by the algorithm, an estimate of the atmospheric disorder (TA) is made.

For example, this estimate is made using the following relationship:

$$TA = 11.1 \frac{ln ( b \frac{{I}_{0}}{{I}_{cc}} )}{m} + 1 with b = 0.664 + 0.163 \cdot exp ( \frac{- h}{8000} )$$

where h is the altitude of the site considered, l₀ is the extraterrestrial solar illumination (W·m²), I_{cc} is the DNI per clear sky (W·m⁻²), and m is the relative optical air mass.

Advantageously, the method according to the invention further comprises the following step:

(h) Calculation of the solar profile from the analysis of the radial distribution of the luminance.

According to the invention, to obtain the solar profile, the DNI is measured along a line of pixels passing through the center of the Sun on the image. By repeating this measurement for a plurality of angles, we thus obtain a radial distribution of the luminance L. This avoids advantageously the use of the instrument SAM (see above), the cost of which is very high.

In addition, the measurement of the solar profile according to the invention is more precise than a measurement with the SAM instrument, because the measurement according to the invention takes into account the anisotropy of the luminance around the Sun (whereas the SAM instrument supposes, incorrectly, a radial symmetry of solar radiation).

1. System of measurement of the solar radiation comprising a camera provided with a hemispherical objective and comprising a sensor adapted to receive light to generate an image and a processor able to:
perform a calibration geometry of the camera in order to obtain the correspondence between the system of coordinates of pixels of the image and the system of coordinates of said camera;
calculate the solid angle subtended by each pixel of said image, in order to weight the value of the luminance in subsequent calculations;
carry out a second calibration of the camera by comparing the theoretical position of the Sun and its position on the image, of how to obtain the correspondence between the system of coordinates of said camera and the cardinal points;
calculate the angle between each pixel and the zenith PZA, the angle between each pixel and the azimuth PAA, the angle between the Sun and the zenith SZ, and the angle between the Sun and the azimuth SAA, then the angle between each pixel and the Sun SPA, by the relationship:
cos(SPA)=cos(SZA)·cos(PZA)+sin(SZA)·sin(PZA)·cos(|SAA−PAA|)
obtain a high dynamic image of the sky.
calculate the Global Horizontal Irradiance index σ_{GHI}, the Direct Normal Irradiance index σ_{DNI}, and the Diffuse Horizontal Irradiance index σ_{DHI}, defined as the sum of the luminances measured by the pixels of said image belonging to a first region of interest Λ₁, to a second region of interest Λ₂ and to a third region of interest Λ₃, respectively, where Ωₚ, Lₚ and PZA are the solid angle subtended by a pixel p, the luminance measured by this pixel and the angle between this pixel and the zenith, respectively:
$${σ}_{GHI} = \frac{{\sum }_{p ∈ {Λ}_{1}} {L}_{p} {Ω}_{p} cos ( PZA )}{{\sum }_{p ∈ {Λ}_{1}} {Ω}_{p}}$$
$${σ}_{DNI} = \frac{{\sum }_{p ∈ {Λ}_{2}} {L}_{p} {Ω}_{p}}{{\sum }_{p ∈ {Λ}_{2}} {Ω}_{p}}$$
$${σ}_{DHI} = \frac{{\sum }_{p ∈ {Λ}_{3}} {L}_{p} {Ω}_{p}}{{\sum }_{p ∈ {Λ}_{3}} {Ω}_{p}}$$
convert the Global Horizontal Irradiance index σ_{GHI}, the Direct Normal Irradiance index σ_{DNI}, and the Diffuse Horizontal Irradiance index σ_{DHI} to Global Horizontal Irradiance, Direct Normal Irradiance and Diffuse Horizontal Irradiance, respectively.

2. The solar radiation measurement system according to claim 1, wherein the said high dynamic range image is obtained by the acquisition of several low dynamic range images taken with different exposure times and then the combination of these images in one high dynamic range image, all while maintaining the linearity of the sensor's camera.

3. The system of measurement of the solar radiation according to claim 1, wherein said first region of interest Λ₁ is the set of pixels of the image verifying PZA<90°, said second region of interest Λ₂ is the set of pixels of the image verifying SPA<β, β being the angle defined as the limit between the circumsolar zone and the rest of the sky, and said third region of interest Λ₃ is the set of pixels of the image verifying {SPA<β}∩{PZA<90°}.

4. The solar radiation measuring system according to claim 1, comprising a waterproof and dustproof protective box in which is housed said camera and which comprises a transparent window located in front of the objective of said camera.

5. The solar radiation measurement system according to claim 4, wherein said box is equipped with a temperature controller capable of regulating the temperature inside said box.

6. The solar radiation measurement system according to claim 1, at least one filter which is adapted to mitigate or modulate the light entering through the objective of said camera.

7. A method of measuring the solar radiation wherein the method uses a camera provided with a hemispherical objective and having a sensor adapted to receive light to generate an image and a processor, and comprises the following stages:
(a) geometrically calibrating the camera in order to obtain the correspondence between the pixel coordinate system of the image supplied by said camera and the coordinate system of the camera;
(b) calculating the solid angle subtended by each pixel of said image, in order to weight the value of the luminance in the subsequent calculations;
(c) calibrating said camera a second time by comparing the theoretical position of the Sun and its position obtained on the image, in order to obtain the correspondence between the coordinates of said camera system and the cardinal points;
(d) calculating the angle between each pixel and the zenith PZA, the angle between each pixel and the azimuth PAA, the angle between the Sun and the zenith SZA, and the angle between the Sun and the azimuth SAA, then the angle between each pixel and the Sun SPA, thanks to the relationship:
cos(SPA)=cos(SZA)·cos(PZA)+sin(SZA)·sin(PZA)·cos(|SAA−PAA|)
(e) obtaining a High Dynamic Range (HDR) image of the sky;
(f) calculating the value of the Global Horizontal Irradiance index σ_{GHI}, the value of the Direct Normal Irradiance index σ_{DNI}, and the value of the Diffuse Horizontal Irradiance index σ_{DHI}, defined as the sum of the luminances measured by the pixels of said image belonging to a first region of interest Λ₁, to a second region of interest Λ₂, and to a third region of interest Λ₃, respectively, where Ωₚ, Lₚ and PZA are the solid angle subtended by a pixel p, the luminance measured by this pixel and the angle between this pixel and the zenith, respectively:
$${σ}_{GHI} = \frac{{\sum }_{p ∈ {Λ}_{1}} {L}_{p} {Ω}_{p} cos ( PZA )}{{\sum }_{p ∈ {Λ}_{1}} {Ω}_{p}}$$
$${σ}_{DNI} = \frac{{\sum }_{p ∈ {Λ}_{2}} {L}_{p} {Ω}_{p}}{{\sum }_{p ∈ {Λ}_{2}} {Ω}_{p}}$$
$${σ}_{DHI} = \frac{{\sum }_{p ∈ {Λ}_{3}} {L}_{p} {Ω}_{p}}{{\sum }_{p ∈ {Λ}_{3}} {Ω}_{p}}$$
(g) carrying out a conversion between the Global Horizontal Irradiance index σ_{GHI}, the Direct Normal Irradiance index σ_{DNI}, and the Diffuse Horizontal Irradiance index σ_{DHI}, and the Global Horizontal Irradiance, Direct Normal Irradiance and Diffuse Horizontal Irradiance, respectively.

8. The method for measuring solar radiation according to the claim 7, further comprising the following step:
(h) calculating the solar profile by measuring the Direct Normal Irradiance along a row of pixels passing through the center of the Sun in the image, then repeating this measurement for a plurality of angles, in order to obtain a radial distribution of the luminance around the Sun.

9. The system of measurement of the solar radiation according to claim 2, wherein said first region of interest Λ₁ is the set of pixels of the image verifying PZA<90°, said second region of interest Λ₂ is the set of pixels of the image verifying SPA<β, β being the angle defined as the limit between the circumsolar zone and the rest of the sky, and said third region of interest Λ₃ is the set of pixels of the image verifying {SPA<β}∩{PZA<90°}.

10. The solar radiation measuring system according to claim 2, comprising a waterproof and dustproof protective box in which is housed said camera and which comprises a transparent window located in front of the objective of said camera.

11. The solar radiation measuring system according to claim 3, comprising a waterproof and dustproof protective box in which is housed said camera and which comprises a transparent window located in front of the objective of said camera.

12. The solar radiation measurement system according to claim 2, at least one filter which is adapted to mitigate or modulate the light entering through the objective of said camera.

13. The solar radiation measurement system according to claim 3, at least one filter which is adapted to mitigate or modulate the light entering through the objective of said camera.

14. The solar radiation measurement system according to claim 4, at least one filter which is adapted to mitigate or modulate the light entering through the objective of said camera.

15. The solar radiation measurement system according to claim 5, at least one filter which is adapted to mitigate or modulate the light entering through the objective of said camera.

16. The solar radiation measuring system according to claim 9, comprising a waterproof and dustproof protective box in which is housed said camera and which comprises a transparent window located in front of the objective of said camera.

17. The solar radiation measurement system according to claim 9, at least one filter which is adapted to mitigate or modulate the light entering through the objective of said camera.

18. The solar radiation measurement system according to claim 10, at least one filter which is adapted to mitigate or modulate the light entering through the objective of said camera.

19. The solar radiation measurement system according to claim 11, at least one filter which is adapted to mitigate or modulate the light entering through the objective of said camera.
